(19) United States
(12) Patent Application Publication
(10) Pub. No.: US 2005/0288439 A1
(43) Pub. Date: Dec. 29, 2005

(54) Elastomeric compositions having improved mechanical properties and scorch resistance

(76) Inventors: Richard Pazur, Sarnia (CA); Lorenzo Ferrari, Brights Grove (CA)

Correspondence Address: BAYER MATERIAL SCIENCE LLC, 100 BAYER ROAD, PITTSBURGH, PA, 15205, US

(21) Appl. No.: 10/876,324

(22) Filed: Jun. 24, 2004

(30) Foreign Application Priority Data
Jun. 23, 2004 (CA) 2,478,431

(51) Int. Cl. C08G 63/48

(52) U.S. Cl. 525/191

(57) ABSTRACT

The present invention relates to an elastomeric composition containing a rubber and an oxidized polyethylene. The present invention also relates to elastomeric compositions containing a carboxylated nitrile rubber and an oxidized polyethylene. Compositions according to the present invention have improved physical properties including, tensile strength, tear strength, and improved scorch resistance. The present invention is also directed to an elastomer composition containing hydrogenated carboxylated nitrile rubber and a low molecular weight oxidized polyethylene having improved physical properties and scorch resistance.

### FIELD OF THE INVENTION

The present invention relates to an elastomeric composition containing a rubber, preferably a hydrogenated rubber, more preferably a rubber having a carboxylic group and an oxidized polyethylene. Compositions according to the present invention have improved physical properties including, tensile strength, tear strength, and improved scorch resistance. The present invention is also directed to an elastomer composition containing hydrogenated carboxylated nitrile rubber and a low molecular weight oxidized polyethylene having improved physical properties and scorch resistance.

### BACKGROUND OF THE INVENTION

Carboxylated hydrogenated nitrile rubber (HXNBR), prepared by the selective hydrogenation of carboxylated acrylonitrile-butadiene rubber (nitrile rubber; XNBR, a co-polymer containing at least one conjugated diene, at least one unsaturated nitrile, at least one carboxylated monomer and optionally further comonomers), is a specialty rubber which has very good heat resistance, excellent ozone and chemical resistance, and excellent oil resistance. Coupled with the high level of mechanical properties of the rubber (in particular the high resistance to abrasion) it is not surprising that XNBR and HXNBR have found widespread use in the automotive (seals, hoses, bearing pads), oil (stators, well head seals, valve plates), electrical (cable sheathing), mechanical engineering (wheels, rollers) and shipbuilding (pipe seals, couplings) industries, amongst others.

Improvements in the properties of HXNBR are constantly sought, and often for this purpose new and unconventional additives and compounds are mixed or blended. The present invention is directed to a composition having improved physical properties and scorch resistance and to processes for their manufacture.

Low molecular weight oxidized polyethylene is known to emulsify easily with anionic and cationic surfactants and has found use in applications including paper coatings, lubricants, ceramic binders and textile softeners.

It is known to use oxidized polyethylene to disperse rubber additives and fillers and to protect rubber from UV rays, it is not known to add low molecular weight oxidized polyethylene to HXNBR in order to improve the physical properties and scorch resistance of an elastomeric composition. It has now surprisingly been found that oxidized polyethylene addition to HXNBR has significant effects on both physical properties and scorch resistance of the elastomeric composition, while retaining its efficiency as a process aid (lowers Mooney viscosity).

### SUMMARY OF THE INVENTION

The present invention relates to an elastomeric composition containing at least one rubber polymer containing a carboxylate group and an oxidized polyethylene. The present invention also relates to an elastomeric composition containing carboxylated nitrile rubber polymer, which is optionally hydrogenated (“XNBR” or “HXNBR”) and a low molecular weight oxidized polyethylene. The present invention also relates to a process for the preparation of an elastomeric composition containing at least one carboxylated nitrile rubber polymer and a low molecular weight oxidized polyethylene.

Further, the present invention relates to shaped articles, such as seals, hoses, bearing pads, stators, well head seals, valve plates, cable sheathing, wheels, rollers, pipe seals and couplings.

### BRIEF DESCRIPTION OF THE DRAWINGS

FIG. 1 illustrates a comparison of the physical properties, including hardness Shore A2, ultimate tensile, ultimate elongation and stress at 25 and 50% extension of a HXNBR composition containing a low molecular weight polyethylene and a conventional HXNBR composition.

FIG. 2 illustrates a comparison of the Theological behavior of a HXNBR composition containing a low molecular weight polyethylene and a conventional HXNBR composition.

FIG. 3 illustrates a comparison of the abrasion resistance of a HXNBR composition containing a low molecular weight polyethylene and a conventional HXNBR composition.

FIG. 4 illustrates a comparison of the die B and die C tear strengths of a HXNBR composition containing a low molecular weight polyethylene and a conventional HXNBR composition.

FIG. 5 illustrates a comparison of the compression set performance at 100° C. of a HXNBR composition containing a low molecular weight polyethylene and a conventional HXNBR composition.

### DETAILED DESCRIPTION OF THE INVENTION

The present invention includes the use of nitrile rubbers, preferably hydrogenated nitrile rubber, more preferably carboxylated nitrile rubbers, most preferably hydrogenated carboxylated nitrile rubbers. The present invention also includes the use of other rubbers having carboxylic groups.

As used throughout this specification, the term “nitrile rubber” or NBR is intended to have a broad meaning and is meant to encompass a copolymer having repeating units derived from at least one conjugated diene, at least one α,β-unsaturated nitrile and optionally further one or more copolymerizable monomers.

Hydrogenated in this invention is preferably understood by more than 50% of the residual double bonds (RDB) present in the starting nitrile polymer/NBR being hydrogenated, preferably more than 90% of the RDB are hydrogenated, more preferably more than 95% of the RDB are hydrogenated and most preferably more than 99% of the RDB are hydrogenated.

As used throughout this specification, the term “carboxylated nitrile rubber” or XNBR is intended to have a broad meaning and is meant to encompass a copolymer having repeating units derived from at least one conjugated diene, at least one α,β-unsaturated nitrile, at least one alpha-beta-unsaturated carboxylic acid or alpha-beta-unsaturated carboxylic acid derivative and optionally further one or more copolymerizable monomers.

The present invention also includes the use of other rubber monomers having carboxylic groups. Suitable rubbers include XSBR (Styrene-butadiene copolymers and graft polymers with other unsaturated polar monomers such as acrylic acid, methacrylic acid, acrylamide, methacrylamide, N-methoxymethyl methacrylic acid amide, N-acetoxy-methyl methacrylic acid amide, acrylonitrile, hydroxyethylacrylate and/or hydroxyethylmethacrylate with styrene contents of 2-50 wt. % and containing 1-20 wt. % of polar monomers polymerized into the molecule), XNBR, XHNBR (Fully hydrogenated NBR rubber in which up to 100% of the double bonds are hydrogenated), FKM (Fluoroelastomer), ACM (Poly acrylate rubber), EAM (copolymers of ethylene, methyl acrylate and a third carboxyl group-containing component currently sold under the tradename Vamac® from DuPont.) Preferably the present invention includes the use of XNBR and/or HXNBR.

As used throughout this specification, the term HXNBR is intended to have a broad meaning and is meant to encompass XNBR wherein at least 10% of the residual C—C double bonds (RDB) present in the starting XNBR are hydrogenated, preferably more than 50% of the RDB present are hydrogenated, more preferably more than 90% of the RDB are hydrogenated, even more preferably more than 95% of the RDB are hydrogenated and most preferably more than 99% of the RDB are hydrogenated.

The conjugated diene may be any known conjugated diene such as a C₄-C₆ conjugated diene. Preferred conjugated dienes include butadiene, isoprene, piperylene, 2,3-dimethyl butadiene and mixtures thereof. More preferred C₄-C₆ conjugated dienes are butadiene, isoprene and mixtures thereof. The most preferred C₄-C₆ conjugated diene is butadiene.

The α,β-unsaturated nitrile may be any known α,β-unsaturated nitrile, such as a C₃-C₅ α,β-unsaturated nitrile. Preferred C₃-C₅ α,β-unsaturated nitrites include acrylonitrile, methacrylonitrile, ethacrylonitrile and mixtures thereof. The most preferred C₃-C₅ α,β-unsaturated nitrile is acrylonitrile.

The α,β-unsaturated carboxylic acid may be any known α,β-unsaturated acid copolymerizable with the diene(s) and the nitile(s), such as acrylic, methacrylic, ethacrylic, crotonic, maleic, fumaric or itaconic acid. Acrylic and methacrylic are preferred.

The α,β-unsaturated carboxylic acid derivative may be any known α,β-unsaturated acid derivative copolymerizable with the diene(s) and the nitile(s), such as esters, amides and anhydrides, preferably esters and anhydrides of acrylic, methacrylic, ethacrylic, crotonic, maleic, fumaric or itaconic acid.

Preferably, the HXNBR contains in the range of from 39.1 to 80 weight percent of repeating units derived from one or more conjugated dienes, in the range of from 5 to 60 weight percent of repeating units derived from one more unsaturated nitrites and 0.1 to 15 percent of repeating units derived from one or more unsaturated carboxylic acid or acid derivative. More preferably, the HXNBR contains in the range of from 60 to 70 weight percent of repeating units derived from one or more conjugated dienes, in the range of from 20 to 39.5 weight percent of repeating units derived from one or more unsaturated nitrites and 0.5 to 10 percent of repeating units derived from one or more unsaturated carboxylic acid or acid derivative. Most preferably, the HXNBR contains in the range of from 56 to 69.5 weight percent of repeating units derived from one or more conjugated dienes, in the range of from 30 to 37 weight percent of repeating units derived from one or more unsaturated nitrites and 0.5 to 7 percent of repeating units derived from one or more unsaturated carboxylic acid or acid derivative. Preferably said HXNBR is a statistical co-polymer with the carboxylic functions randomly distributed throughout the polymer chains.

Optionally, the HXNBR may further contain repeating units derived from one or more copolymerizable monomers. Repeating units derived from one or more copolymerizable monomers will replace either the nitrile or the diene portion of the nitrile rubber and it will be apparent to the skilled in the art that the above mentioned figures will have to be adjusted to result in 100 weight percent.

The present invention is not restricted to a special process for preparing the hydrogenated carboxylated NBR. However, the HXNBR preferred in this invention is readily available as disclosed in WO-01/77185-A1. For jurisdictions allowing for this procedure, WO-01/77185-A1 is incorporated herein by reference.

The XNBR as well as the HXNBR which forms a preferred component of the elastomer of the invention can be characterized by standard techniques known in the art. For example, the molecular weight distribution of the polymer was determined by gel permeation chromatography (GPC) using a Waters 2690 Separation Module and a Waters 410 Differential Refractometer running Waters Millennium software version 3.05.01. Samples were dissolved in tetrahydrofuran (THF) stabilized with 0.025% BHT. The columns used for the determination were three sequential mixed-B gel columns from Polymer Labs. Reference Standards used were polystyrene standards from American Polymer Standards Corp.

The elastomer according to the present invention further contains oxidized polyethylene. Suitable low molecular weight oxidized polyethylene's have Brookfield viscosities measured at 140° C. from 35 to 400 cps. Preferably, the viscosity is in the range of about 75-300, most preferably of about 100 to 250. The present invention also includes the use of high molecular weight oxidized polyethylene's having Brookfield viscosities measured at 150° C. from 2,500 to 85,000 cps. Preferably the viscosity ranges from about 3,000 to 10,000, more preferably from about 3,500 to 4,500. Preferably, suitable oxidized polyethylene's have acid numbers, measured in mg KOH/g (ASTM D-1386) which vary from 7 to 41, more preferably from 10 to 30, and most preferably from 14 to 20.

Preferably, the low molecular weight oxidized polyethylene is added in quantities which range from about 0.1 to 10, parts per hundred parts rubber. More preferably from about 0.5 to about 6, most preferably from about 1 to about 4, parts per hundred parts rubber.

The inventive elastomer composition according to the present invention further can contain at least one filler. The filler may be an active or an inactive filler or a mixture thereof. The filler may be in particular:

highly dispersed silicas, prepared e.g. by the precipitation of silicate solutions or the flame hydrolysis of silicon halides, with specific surface areas of in the range of from 5 to 1000 m²/g, and with primary particle sizes of in the range of from 10 to 400 nm; the silicas can optionally also be present as mixed oxides with other metal oxides such as those of Al, Mg, Ca, Ba, Zn, Zr and Ti;

synthetic silicates, such as aluminum silicate and alkaline earth metal silicate like magnesium silicate or calcium silicate, with BET specific surface areas in the range of from 20 to 400 m²/g and primary particle diameters in the range of from 10 to 400 nm;

natural silicates, such as kaolin and other naturally occurring silica;

glass fibers and glass fiber products (matting, extrudates) or glass microspheres;

carbon blacks; the carbon blacks to be used here are prepared by the lamp black, furnace black or gas black process and have preferably BET (DIN 66 131) specific surface areas in the range of from 20 to 200 m²/g, e.g. SAF, ISAF, HAF, FEF or GPF carbon blacks;

rubber gels, especially those based on polybutadiene, butadiene/styrene copolymers, butadiene/acrylonitrile copolymers and polychloroprene; or mixtures thereof.

magnetoplumbite-structure ferrite particles such as barium ferrite particles, strontium ferrite particles or barium-strontium ferrite particles having an average particle size of from 0.1 to 20.0 μm, a BET specific surface area of from 1 to 10 m/g, and a coercive force (iHc) of from 1,500 to 7,000 Oe,

powdered, optionally modified with organic modifiers, smectite clays, such as sodium or calcium montmorillonite, or synthetic clays such as hydrotalcite and laponite

Examples of useful mineral fillers include silica, silicates, clay such as bentonite, gypsum, alumina, titanium dioxide, talc, mixtures of these, and the like. These mineral particles have hydroxyl groups on their surface, rendering them hydrophilic and oleophobic. This exacerbates the difficulty of achieving good interaction between the filler particles and the rubber. For many purposes, the preferred mineral is silica, especially silica made by carbon dioxide precipitation of sodium silicate. Dried amorphous silica particles suitable for use in accordance with the invention may have a mean agglomerate particle size in the range of from 1 to 100 microns, or, for example, between 10 and 50 microns or, further for example, between 10 and 25 microns. According to the present invention, less than 10 percent by volume of the agglomerate particles should be below 5 microns or over 50 microns in size. A suitable amorphous dried silica moreover usually has a BET surface area, measured in accordance with DIN (Deutsche Industrie Norm) 66131, of in the range of from 50 and 450 square meters per gram and a DBP absorption, as measured in accordance with DIN 53601, of in the range of from 150 and 400 grams per 100 grams of silica, and a drying loss, as measured according to DIN ISO 787/11, of in the range of from 0 to 10 percent by weight. Suitable silica fillers are available under the trademarks HiSil® 210, HiSil® 233 and HiSil® 243 from PPG Industries Inc. Also suitable are Vulkasil S and Vulkasil N, from Bayer AG.

Often, use of carbon black as a filler is preferable. Usually, carbon black is present in the polymer composition in an amount of in the range of from 0.1 to 200 phr, preferably 10 to 100, more preferably 40 to 80 phr. Further, it might be advantageous to use a combination of carbon black and mineral filler in the inventive polymer composite. In this combination the ratio of mineral fillers to carbon black is usually in the range of from 0.05 to 20, preferably 0.1 to 10.

The rubber elastomer according to the present invention can contain further auxiliary products for rubbers, such as reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, metal oxides, and activators such as triethanolamine, polyethylene glycol, hexanetriol, etc., which are known to the rubber industry. The rubber aids are used in conventional amounts, which depend inter alia on the intended use. Conventional amounts are e.g. from 0.1 to 50 wt. %, based on rubber. According to the present invention, the composition can contain in the range of 0.1 to 20 phr of an organic fatty acid as an auxiliary product, such as a unsaturated fatty acid having one, two or more carbon double bonds in the molecule which more preferably includes 10% by weight or more of a conjugated diene acid having at least one conjugated carbon-carbon double bond in its molecule. Those fatty acids can have in the range of from 8-22 carbon atoms, or for example from 12-18. Examples include stearic acid, palmitic acid and oleic acid and their calcium-, zinc-, magnesium-, potassium- and ammonium salts.

According to the present invention, the composition can contain in the range of 0.1 to 20 phr of an organic fatty acid as an auxiliary product, such as a unsaturated fatty acid having one, two or more carbon double bonds in the molecule which more preferably includes 10% by weight or more of a conjugated diene acid having at least one conjugated carbon-carbon double bond in its molecule. Those fatty acids can have in the range of from 8-22 carbon atoms, or for example from 12-18. Examples include stearic acid, palmitic acid and oleic acid and their calcium-, zinc-, magnesium-, potassium- and ammonium salts.

According to the present invention, the composition can contain in the range of 5 to 50 phr of an acrylate as an auxiliary product. Suitable acrylates are known from EP-A1-0 319 320, in particular p. 3, I. 16 to 35, from U.S. Pat. No. 5,208,294, see Col. 2, I. 25 to 40, and from U.S. Pat. No. 4,983,678, in particular Col. 2, I. 45 to 62. Reference is made to zinc acrylate, zinc diacrylate or zinc dimethacrylate or a liquid acrylate, such as trimethylolpropane-trimethacrylate (TRIM), butanedioldimethacrylate (BDMA) and ethylenglycoldimethacrylate (EDMA). It might be advantageous to use a combination of different acrylates and/or metal salts thereof. It may also be advantageous to use metal acrylates in combination with a Scorch-retarder such as sterically hindered phenols (e.g. methyl-substituted aminoalkylphenols, such as 2,6-di-tert.-butyl-4-dimethylaminomethylphenol).

An antioxidant may be used in preparing a compound according to the present invention. Examples of suitable antioxidants include p-dicumyl diphenylamine (Naugard® 445), Vulkanox® DDA (a diphenylamine derivative), Vulkanox® ZMB2 (zinc salt of methylmercapto benzimidazole), Vulkanox® HS (polymerized 1,2-dihydro-2,2,4-trimethyl quinoline) and Irganox® 1035 (thiodiethylene bis(3,5-di-tert.-butyl-4-hydroxy)hydrocinnamate or thiodiethylene bis(3-(3,5-di-tert.-butyl-4-hydroxyphenyl)propionate supplied by Ciba-Geigy. Vulkanox is a trademark of Bayer AG.

Similarly, in preparing compounds according to the present invention it is useful to employ a crosslinking agent, including commercially available agents including sulfur/sulfur accelerator systems, diamines and peroxides. Most preferred are the peroxide based vulcanizing agents due to the excellent thermal stability conveyed by the carbon-carbon linkages between polymer chains. Useful peroxide crosslinking agents, include dicumyl peroxide (Di-Cup 40KE), di-tert.-butyl peroxide, benzoyl peroxide, 2,2′-bis(tert.-butylperoxy diisopropylbenzene (Vulcup® 40KE), benzoyl peroxide, 2,5-dimethyl-2,5-di(tert-butylperoxy)-hexyne-3,2,5-dimethyl-2,5-di(benzoylperoxy)hexane, (2,5-bis(tert.-butylperoxy)-2,5-dimethyl hexane and the like. Preferred curing agents are readily determined by means of a few preliminary experiments, which is within the scope of one skilled in the art. A preferred peroxide curing agent is commercially available under the tradename Di-Cup 40KE. The peroxide curing agent (60% active) is suitably used in an amount of 0.1 to 15 parts per hundred parts of rubber (phr), preferably 4 to 10 phr. Too much peroxide may lead to undesirably violent reaction.

Vulcanizing co-agents can also be added to the composition of the present invention. Mention is made of triallyl isocyanurate (TAIC), commercially available under the trademark DIAK 7 from DuPont Or N,N′-m-phenylene dimaleimide know as HVA-2 (DuPont Dow), triallyl cyanurate (TAC) or liquid polybutadiene known as Ricon D 153 (supplied by Ricon Resins). Amounts can be equivalent to the peroxide curative or less, preferably equal.

The present invention also includes the use of activators such as zinc peroxide (50% on an inert carrier) using Struktol ZP 1014 in combination with the peroxide. Amounts can be from 0.1 to 15, preferably from 4 to 10 phr.

The elastomeric composition of the present invention may further contain other natural or synthetic rubbers such as BR (polybutadiene), ABR (butadiene/acrylic acid-C₁-C₄-alkylester-copolymers), EVM (ethylene vinyl acetate-copolymers), AEM (ethylene acrylate-copolymers), CR (polychloroprene), IR (polyisoprene), SBR (styrene/butadiene-copolymers) with styrene contents in the range of 1 to 60 wt %, EPDM (ethylene/propylene/diene-copolymers), FKM (fluoropolymers or fluororubbers), and mixtures of the given polymers. Careful blending with these rubbers often reduces cost of the polymer blend without sacrificing the processability. The amount of natural and/or synthetic rubbers will depend on the process condition to be applied during manufacture of shaped articles and is readily available by few preliminary experiments.

The ingredients of the elastomer composition are often mixed together, suitably at an elevated temperature that may range from 25° C. to 200° C. Normally the mixing time does not exceed one hour and a time in the range from 2 to 30 minutes is usually adequate. Mixing is suitably carried out in an internal mixer such as a Banbury mixer, or a Haake or Brabender miniature internal mixer. A two roll mill mixer also provides a good dispersion of the additives within the elastomer. An extruder also provides good mixing, and permits shorter mixing times. It is possible to carry out the mixing in two or more stages, and the mixing can be done in different apparatus, for example one stage in an internal mixer and one stage in an extruder. However, it should be taken care that no unwanted pre-crosslinking (=scorch) occurs during the mixing stage. For compounding and vulcanization see also: Encyclopedia of Polymer Science and Engineering, Vol. 4, p. 66 et seq. (Compounding) and Vol. 17, p. 666 et seq. (Vulcanization).

The elastomeric composition according to the present invention is especially suitable for injection molding articles such as the present invention relates to shaped articles, such as seals, hoses, bearing pads, stators, well head seals, valve plates, cable sheathing, wheels, rollers, pipe seals and couplings.

The invention is further illustrated but is not intended to be limited by the following examples in which all parts and percentages are by weight unless otherwise specified.

### EXAMPLES

Description of Tests:

Cure Rheometry:

Vulcanization testing was carried out on a Moving Die Rheometer (MDR 2000(E)) using a frequency of oscillation of 1.7 Hz and a 1° arc at 150° C. for 60 minutes total run time. The test procedure follows ASTM D-5289.

Compound Mooney Viscosity and Scorch:

A large rotor was used for these tests in compliance with the ASTM method D-1646. The compound Mooney viscosity was determined at 100° C. by preheating the sample 1 minute and then, measuring the torque (Mooney viscosity units) after 4 minutes of shearing action caused by the viscometer disk rotating at 2 r.p.m. Mooney scorch measurements taken as the time from the lowest torque value to a rise of 5 Mooney units (t05) were carried out at 125° C.

Stress-Strain:

Samples were prepared by curing a macro sheet at 150° C. for 180 minutes. Afterwards, samples were died out into standard ASTM die C dumbells. The test was conducted at 230° C. and complies with ASTM D-412 Method A.

Hardness:

All hardness measurements were carried out with an A-2 type durometer following the procedure outlined in ASTM D-2240.

Tear Resistance:

A tensile sheet cured 180 minutes at 150° C. was used to prepare appropriate samples of Die B and Die C geometries. Both tests are designed to give an indication of the resistance to tear of the rubber. The test procedure complies with ASTM D 624.

Pico Abrasion:

This test method complies with ASTM D-2228 and indicates the cutting abrasion resistance of the vulcanizates.

Din Abrasion:

Abrasion resistance is determined according to test method DIN 53 516. The volume loss by rubbing the rubber specimen with an emery paper of defined abrasive power is measured and reported.

Compression Set

This testing complies with ASTM D395 (Method B). Solid button type samples were cured for 180 minutes at 150° C. and the sample subjected to a 10% compression deflection during hot air aging.

### Preparations of Examples

A laboratory size Banbury BR-82 (1.6 L capacity) internal mixer cooled at 30° C. was used to prepare the Examples. Rotor speed was held constant during mixing at 55 rpm. At 0 minutes, the Therban polymer was added. At 45 seconds, the Armeen 18D, Vanfre Vam, A-C 629A, Carbon black and Naugard 445 was added to the mixer. At 2 minutes, the Saret 517 coagent was added. A sweep was performed at 190 seconds and finally the mix was dumped at 270 seconds. The dropped mix was allowed to cool for four hours prior to addition of curatives. The curatives Di-Cup and Struktol ZP 1014 were both added on a 10″ by 20″ two roll mill cooled at 30° C.

The formulations used were based on the recipes according to Table 1, all quantities are based per one hundred parts rubber.

TABLE 1
Formulations

| | Ex. 1 | |
|---|---|---|
| Components | (Comp) | Ex. 2 |
| THERBAN ® XT VP KA 8889 | 100 | 100 |
| ARMEEN 18D | 0.5 | 0.5 |
| VANFRE VAM | 2 | 2 |
| A-C 629A | 0 | 3 |
| CARBON BLACK, N 550 | 70 | 70 |
| NAUGARD ® 445 | 1.1 | 1.1 |
| SARET ® 517 | 25 | 25 |
| DI-CUP 40 KE 40% | 7 | 7 |
| STRUKTOL ZP 1014 | 8 | 8 |

Therban® XT VP KA 8889 from Bayer AG

Armeen® 18D is an octadecylamine from Akzo Nobel

Vanfre® VAM is a complex organic alkyl acid phosphate processing aid available from R.T. Vanderbilt Company.

A-C®-629A is a low molecular weight oxidized polyethylene from Allied Signal.

Carbon Black N 550 available from Cabot Tire Blacks.

Naugard® 445 is a diphenylamine A/O available from Crompton.

Saret® 517 is a co-agent available from Sartomer.

Di-Cup 40KE 40% is a dicumyl peroxide supplied on burgess clay available from Geo Chemicals

Struktol® ZP 1014 is a zinc peroxide (50% on an inert carrier) activator available from Struktol.

TABLE 2
PROPERTIES

| PROPERTY | Ex. 1 | Ex. 2 |
|---|---|---|
| Hardness Shore A2 (pts) | 89 | 89 |
| Ultimate Tensile (MPa) | 17.8 | 20.8 |
| Ultimate Elongation (%) | 47 | 91 |
| Stress @ 25% (MPa) | 10.7 | 8.6 |
| Stress @ 50% (MPa) | 0 | 14.9 |
| Mooney scorch, t05, 135° C. (min) | 6.7 | 19.7 |
| ML (1 + 4 @ 100° C.) (MU) | 84.3 | 58.8 |
| Maximum torque, 150° C.(dN.m) | 52.8 | 92.8 |
| T′90, 150° C. (min) | 50 | 36.8 |
| DIN abrasion (volume loss, mm³) | 264 | 235 |
| PICO abrasion (volume loss, cm³) | 0.0013 | 0.0010 |
| DIE B Tear strength (kN/m) | 28.5 | 55.8 |
| DIE C Tear strength (kN/m) | 25.1 | 29.3 |
| Compression set, 100° C., 70 hrs | 60.5 | 51.7 |
| Compression set, 100° C., 168 hrs | 66.6 | 55.2 |

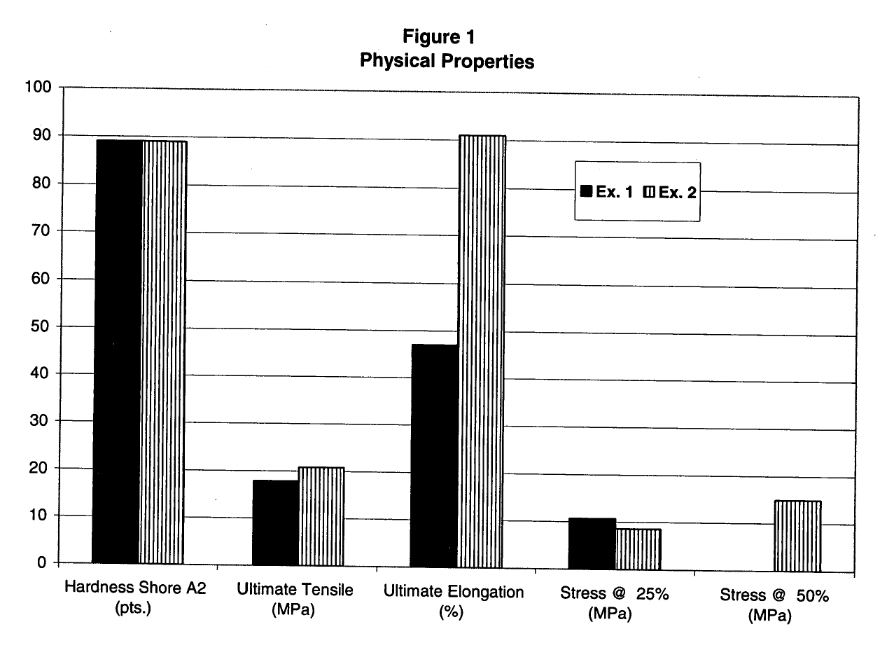

The physical properties clearly improve with the addition of the oxidized polyethylene as illustrated in Table 2 and FIG. 1. For a 90 shore A2 hardness material, it is seen that both ultimate tensile and elongation increase significantly with the addition of oxidized polyethylene. Little or no change is seen in the hardness or stress at 25 and 50% values. Increase of tensile and elongation properties without sacrificing moduli values are coveted qualities in rubber compounds.

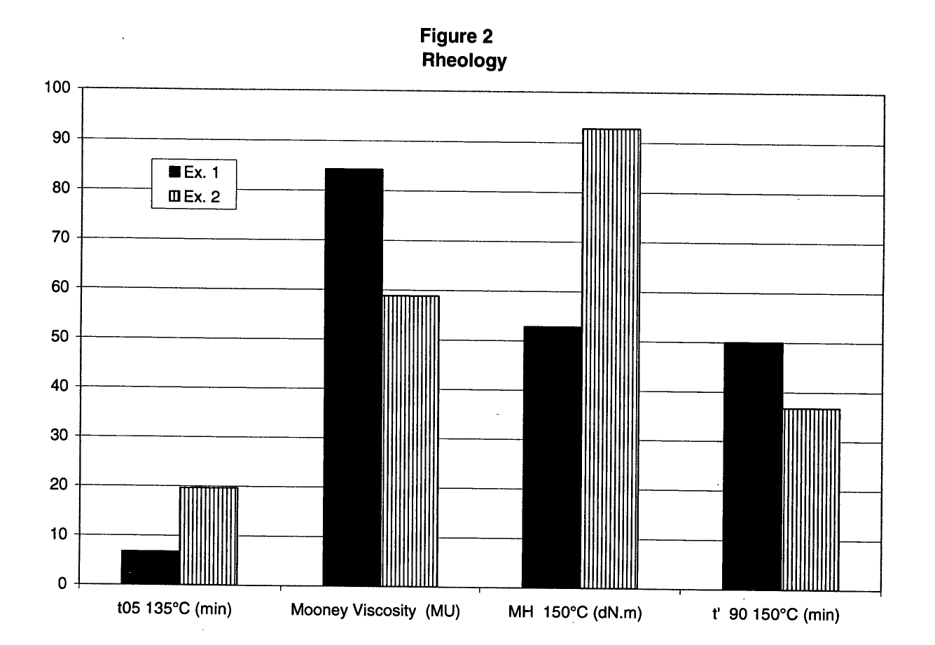

FIG. 2 clearly illustrates the rheological advantages of oxidized polyethylene addition to HXNBR. The scorch safety is more than 3 times better in Example 2 compared to Example 1. Longer scorch safety is indicative of a larger processing window during rubber transformation with less worry of premature vulcanization occurring in the processing equipment which causes shut down time and loss in productivity. According to the curing behavior, Example 2 provides a compound with a high maximum torque (higher level of overall stiffness) coupled with a faster time to 90% cure. Faster cure times lead generally to quicker cycle times and a subsequent increase in productivity.

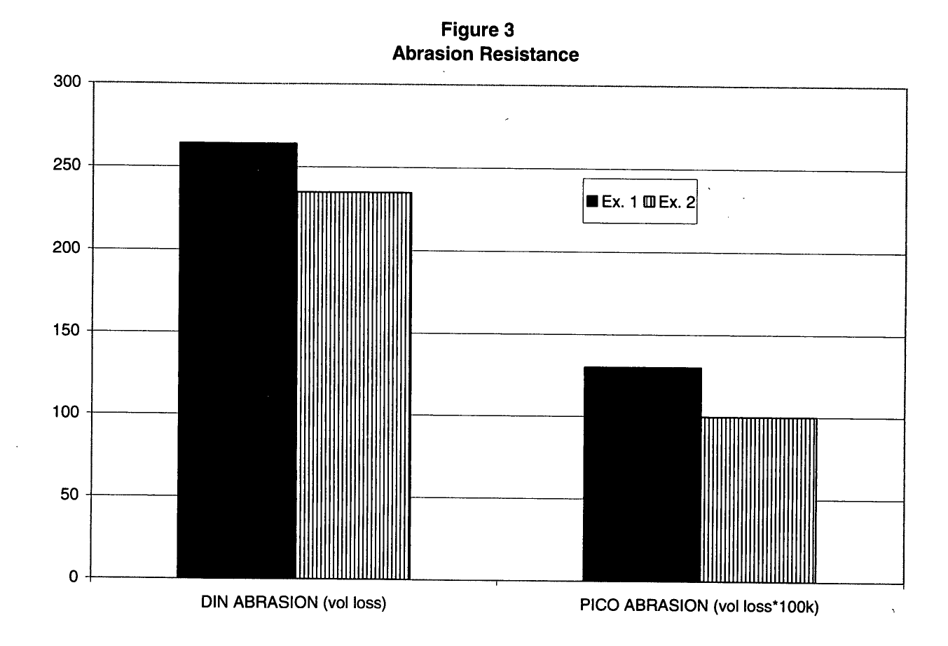

Improved abrasion is clearly shown in FIG. 3 as measured by the DIN and Pico abrasion methods. Improved abrasion resistance indicates the final rubber part will wear longer and provide a longer overall service life.

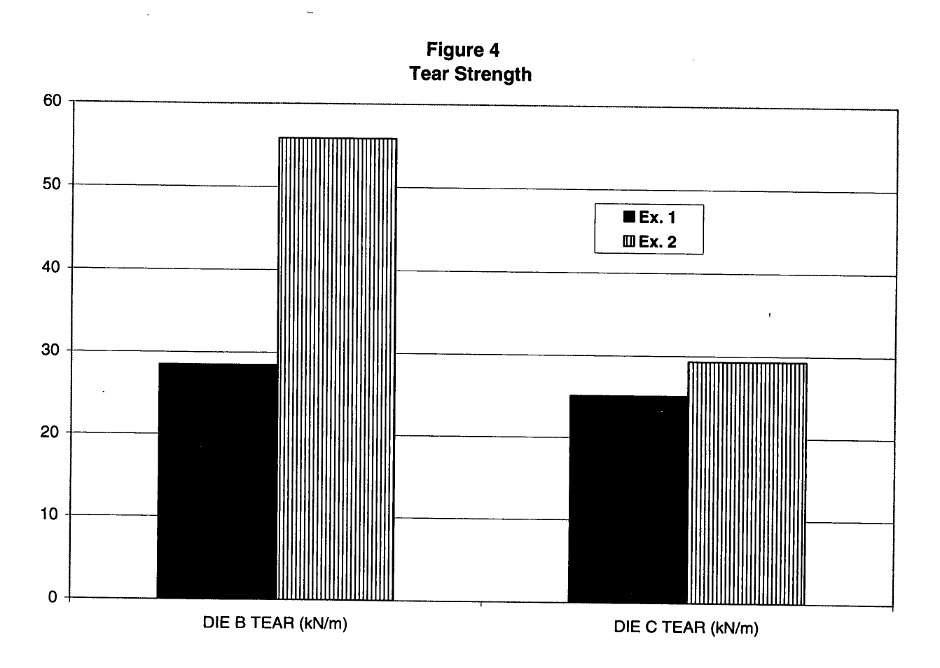

FIG. 4 demonstrates the dramatic improvement in tear B resistance of Example 2 compared to Example 1. Tear C resistance is also improved upon the addition of oxidized polyethylene. Premature failure of rubber parts by a tear mechanism, either initiation or propagation, is lessened when using an elastomeric compound according to the present invention.

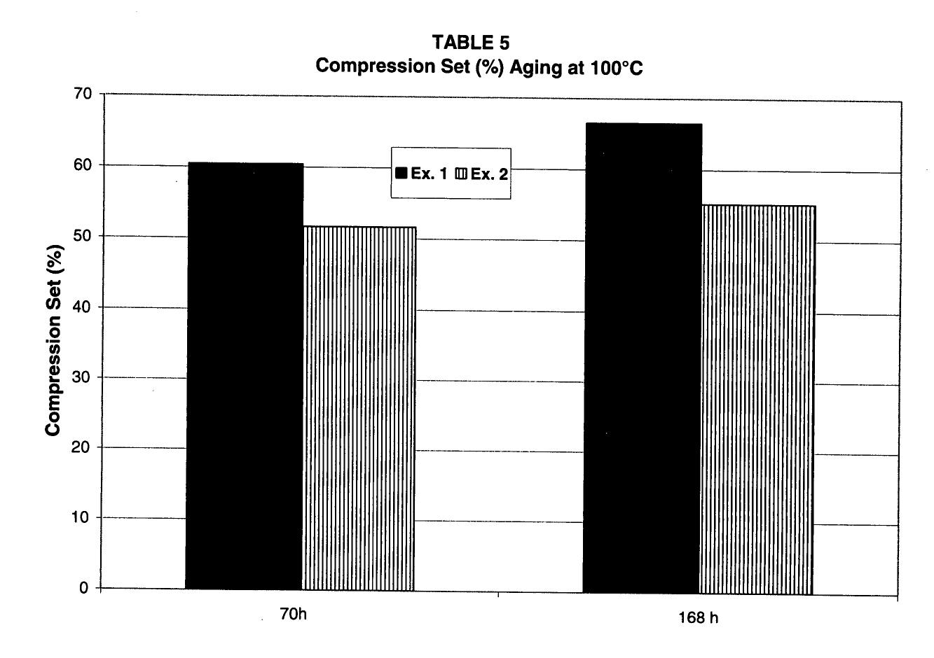

FIG. 5 illustrates that the compression set behavior of Example 2 is better than Example 1. This effect is seen after 70, 168 and 504 hours of aging at 100° C. These results indicate the vulcanizate's ability to retain elastic properties after prolonged action of compressive stress coupled with hot air aging is improved in the presence of oxidized polyethylene.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. An elastomeric composition comprising a carboxylated rubber and from 0.1 to 10 parts per hundred parts rubber of an oxidized polyethylene.

2. The composition according to claim 1, wherein the carboxylated rubber is selected from the group consisting of XSBR, XNBR, XHNBR, FKM, ACM and EAM.

3. The composition according to claim 2, wherein carboxylated rubber is XNBR.

4. The composition according to claim 2, wherein the carboxylated rubber is HXNBR.

5. The rubber composition according to claim 1, wherein the oxidized polyethylene is a low molecular weight polyethylene having a viscosity measured at 140° C. from 35 to 400 cps.

6. The rubber composition according to claim 1, wherein the oxidized polyethylene is a high molecular weight polyethylene having a viscosity measured at 150° C. from 2,500 to 85,000 cps.

7. The rubber composition according to claim 1, further comprising at least one filler.

8. The rubber composition according to claim 1, further comprising reaction accelerators, vulcanizing accelerators, antioxidants, foaming agents, anti-aging agents, heat stabilizers, processing aids, plasticizers and/or activators.

9. A method for improving the scorch resistance of an elastomer composition comprising admixing an oxidized polyethylene and a carboxylated rubber.

10. A process for preparing and elastomeric composition comprising admixing a carboxylated rubber and from 0.1 to 10 parts per hundred parts rubber of an oxidized polyethylene.

11. The process according to claim 10, wherein the carboxylated rubber is selected from the group consisting of XSBR, XNBR, XHNBR, FKM, ACM and EAM.

12. The process according to claim 11, wherein carboxylated rubber is XNBR.

13. The process according to claim 11, wherein the carboxylated rubber is HXNBR.

14. The process according to claim 10, wherein the oxidized polyethylene is a low molecular weight polyethylene having a viscosity measured at 140° C. from 35 to 400 cps.

15. The process according to claim 10, wherein the oxidized polyethylene is a high molecular weight polyethylene having a viscosity measured at 150° C. from 2,500 to 85,000 cps.

16. An elastomeric composition comprising a nitrile rubber and from 0.1 to 10 parts per hundred parts rubber of an oxidized polyethylene.

17. The elastomeric composition according to claim 16, wherein the nitrile rubber is carboxylated.

18. The elastomeric composition according to claim 17, wherein the carboxylated nitrile rubber is hydrogenated.
